(19) United States
(12) Patent Application Publication
(10) Pub. No.: US 2026/0057224 A1
(43) Pub. Date: Feb. 26, 2026

(54) SPIKING NEUROMORPHIC CIRCUITS FOR SOLVING FINITE ELEMENT PROBLEMS

(71) Applicant: National Technology & Engineering Solutions of Sandia, LLC, Albuquerque, NM (US)

(72) Inventors: Bradley Harold Theilman, Albuquerque, NM (US); James Bradley Aimone, Keller, TX (US)

(21) Appl. No.: 18/812,419

(22) Filed: Aug. 22, 2024

(51) Int. Cl. G06N 3/049; G06N 3/065

(52) U.S. Cl. CPC G06N 3/049; G06N 3/065

(57) ABSTRACT

A spiking neuromorphic circuit that instantiates a finite element methods (FEM) mesh is provided. The circuit comprises a number of groups of spiking neurons, wherein each group of spiking neurons represents a mesh node in the FEM mesh, wherein the FEM mesh represents a linear system. A bias current represents conditions in the linear system. Interaction weights between adjacent mesh nodes are proportional to the linear system represented by the FEM mesh. The spiking neurons within each group of spiking neurons spike in a manner that flows to a solution variable for the respective mesh node.

### STATEMENT OF GOVERNMENT INTEREST

This invention was made with United States Government support under Contract No. DE-NA0003525 between National Technology & Engineering Solutions of Sandia, LLC and the United States Department of Energy. The United States Government has certain rights in this invention.

### BACKGROUND

### 1. Field

The present disclosure relates generally to finite element methods, and more specifically to solutions for finite element methods with neuromorphic circuits.

### 2. Background

Finite element methods (FEM) continue to be the leading numerical techniques for solving partial differential equations (PDEs) arising in mission-critical applications. Elaboration of these methods to large, complex models has driven many advances in supercomputing and parallel computation. The power resource demands of modern supercomputers capable of meeting these requirements are approaching sustainability limits. Emerging computational paradigms such as neuromorphic computing promise to reset these scaling curves and yield new, energy-efficient solvers for current and future numerical problems.

Because the nascent computational basis previously explored for neuromorphic computers is incommensurate with traditional parallel scientific computation, a new approach is required to create neuromorphic algorithms for numerical computing that realize the potential advantages of neuromorphic computing.

Therefore, it would be desirable to have a method and apparatus that take into account at least some of the issues discussed above, as well as other possible issues.

### SUMMARY

An illustrative embodiment provides a spiking neuromorphic circuit that instantiates a finite element methods (FEM) mesh. The circuit comprises a number of groups of spiking neurons, wherein each group of spiking neurons represents a mesh node in the FEM mesh, wherein the FEM mesh represents a linear system. A bias current represents conditions in the linear system. Interaction weights between adjacent mesh nodes are proportional to the linear system represented by the FEM mesh. The spiking neurons within each group of spiking neurons spike in a manner that flows to a solution variable for the respective mesh node.

Another illustrative embodiment provides a spiking neuromorphic circuit that instantiates a finite element methods (FEM) problem for a sparse linear system. The circuit comprises a number of analog circuits, wherein each analog circuit comprises a number of spiking neurons. External inputs and outputs of the analog circuits are implemented with digital spikes. Each analog circuit corresponds to a mesh node in one of a number of hierarchically arranged FEM meshes that represent the linear system at different levels of resolution, wherein overall convergence rate is independent of FEM mesh size. Synaptic weights between the spiking neurons change iteratively according to changes in the linear system resulting from solutions to the linear system at different time steps. Interaction weights between adjacent mesh nodes are proportional to the sparse linear system represented by the FEM meshes. All FEM meshes operate concurrently and interact with each other via weight matrices that correspond to relaxation and prolongation operators. A bias current represents conditions in the sparse linear system, wherein changes in the bias current represent changes in the conditions of the sparse linear system over time. The spiking neurons within each analog circuit spike in a manner that flows to a solution variable for the respective mesh node.

Another illustrative embodiment provides a method of instantiating a finite element methods (FEM) mesh in a spiking neuromorphic circuit. The method comprises generating the FEM mesh to represent a linear system, wherein the FEM mesh comprises a number of mesh nodes, wherein interaction weights between adjacent mesh nodes are proportional to the linear system represented by the FEM mesh. A group of spiking neurons is assigned to represent each mesh node in the FEM mesh. A bias current is applied to the spiking neurons in each mesh node, wherein the bias current represents conditions in the linear system. The spiking neurons within each group of spiking neurons spike in a manner that flows to a solution variable for the respective mesh node.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a block diagram of a finite element system in accordance with an illustrative embodiment;

FIG. 2 depicts a diagram illustrating mapping of spiking neurons to a FEM mesh in accordance with an illustrative embodiment;

FIG. 3 depicts the operation of a neuromorphic finite element algorithm in accordance with an illustrative embodiment;

FIG. 4A illustrates the readout of a spiking neurons in a mesh node in accordance with an illustrative embodiment;

FIG. 4B illustrates the summation of neuron spikes in a mesh node in accordance with an illustrative embodiment;

FIG. 5 depicts a diagram illustrating a neuromorphic multigrid in accordance with an illustrative embodiment;

FIG. 6 depicts a diagram illustrating a nonlinear solver employing synaptic plasticity in accordance with an illustrative embodiment;

FIG. 7 depicts a flowchart illustrating process for instantiating a finite element methods (FEM) mesh in a spiking neuromorphic circuit in accordance with an illustrative embodiment; and

FIG. 8 is a diagram of a data processing system depicted in accordance with an illustrative embodiment.

### DETAILED DESCRIPTION

The illustrative embodiments recognize and take into account that neuromorphic computing is beginning to show demonstrable advantages for certain problems in scientific computing. We have developed a neuromorphic algorithm that instantiates existing, well-understood finite element mathematics on neuromorphic computers.

The illustrative embodiments also recognize and take into account that neuromorphic computing is likely to show advantages for finite element computations specifically because certain characteristics of scientific problems are well-adapted to neuromorphic architectures. The locality of physical interactions often results in sparse and geometrically constrained computational problems. In von Neumann architectures, with separate compute and memory, this leads to irregular memory access patterns placing significant demands on memory bandwidth. In contrast, neuromorphic architectures are optimized for efficient local communication and computation. In other words, the architecture itself mirrors the structure of the computation. The information for a sparse computation is produced near and easily routed to wherever it is required. This is the key algorithmic principle that has enabled neuromorphic advantages in scientific computation such as random walks and graph algorithms.

The illustrative embodiments also recognize and take into account that a neuromorphic implementation of finite element methods would enable more energy-efficient high resolution FEM solutions. This capability will provide greater throughput from investments in large-scale computing systems and expand the radius in which large FEM models may be deployed.

The illustrative embodiments provide spiking neuromorphic circuits that by virtue of their spiking dynamics are arranged such that their spiking activity converges to the solution of systems of equations arising from finite element methods (FEM) for solving partial differential equations. Several spiking neurons are associated to each element (mesh node) and are connected via weighted synaptic connections to other neurons within that element and between adjacent elements. These synaptic weights are chosen based on a formula that converts the finite element problem into the required weight values, essentially embedding the geometry of the problem directly into the neuromorphic circuit. With this connectivity, the neurons spike sparsely and interact in such a way that their combined activity represents the solution of the finite element problem.

These circuits generalize in several ways. Different forcing functions may be applied by biasing individual neurons, such that a fixed circuit can continuously solve a given PDE on a given domain with new solutions to previous versions of the system. The circuits may be elaborated to support larger systems of equations or finer FEM meshes. The circuits may be implemented using a variety of neuromorphic platforms that support leaky integrate and fire (LIF) dynamics. By accomplishing the computation with spiking neurons, the illustrative embodiments solve these classes of problems in a fundamentally different way than traditional computational architectures.

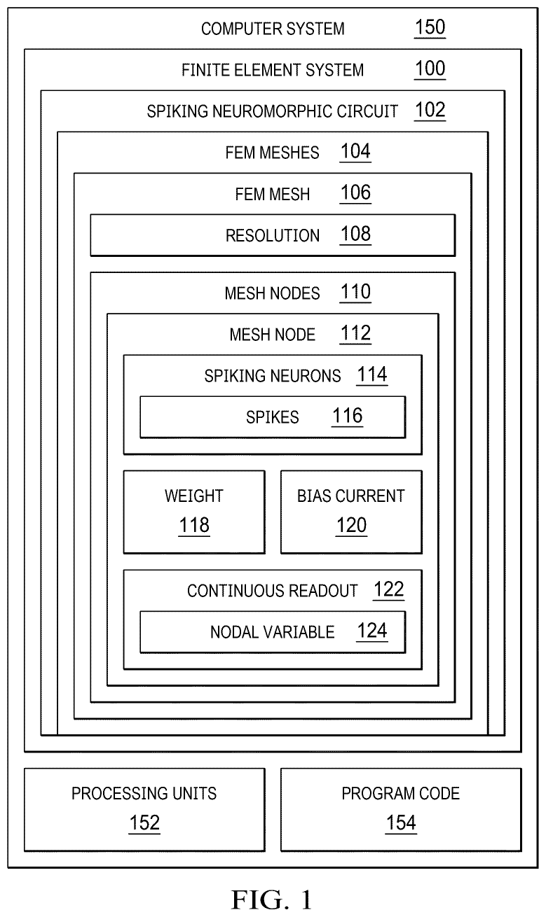

FIG. 1 depicts a block diagram of a finite element system in accordance with an illustrative embodiment. Finite element system 100 comprises spiking neuromorphic circuit 102 that instantiates one or more finite element methods (FEM) meshes 104 that represent a sparse linear system. The sparse linear system may model a linear partial differential equation (PDE).

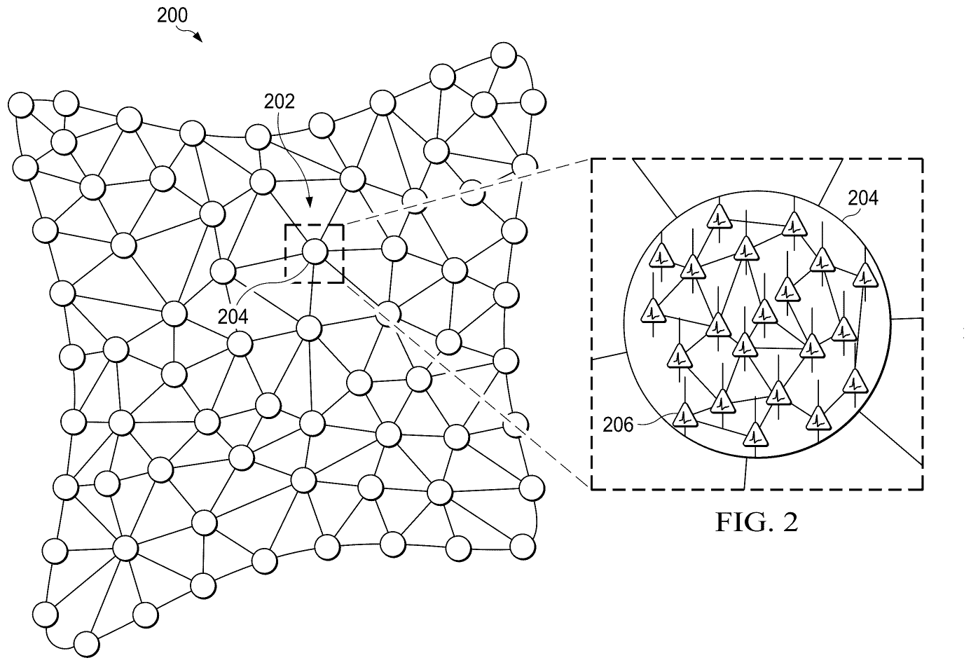

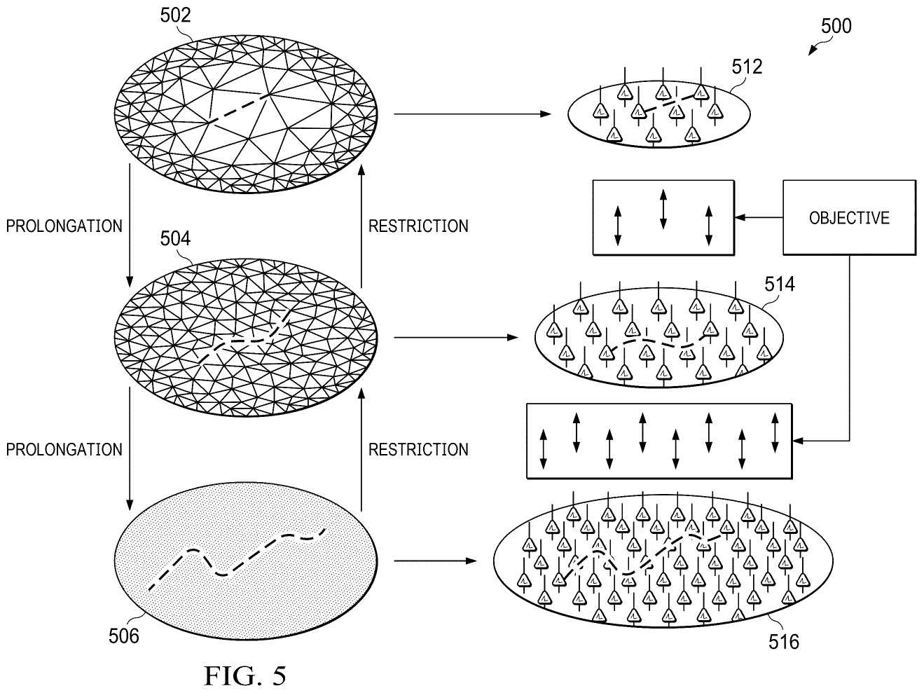

FEM meshes 104 may be arranged hierarchically according to the respective resolution 108 of each FEM mesh 106 (see FIG. 5). Each FEM mesh 106 comprises a number of mesh nodes 110. Each mesh node 112 is assigned a population of spiking neurons 114 of the spiking neuromorphic circuit 102 (see FIG. 2). Weight 118 of each mesh node 112 is proportional to the linear system represented by the FEM mesh 106.

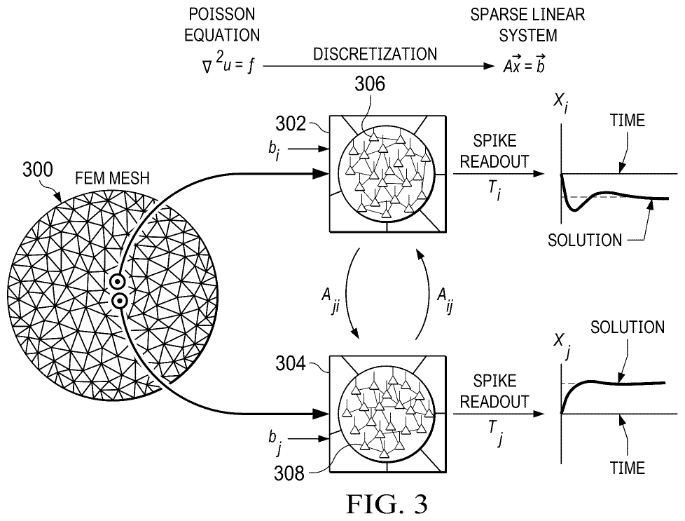

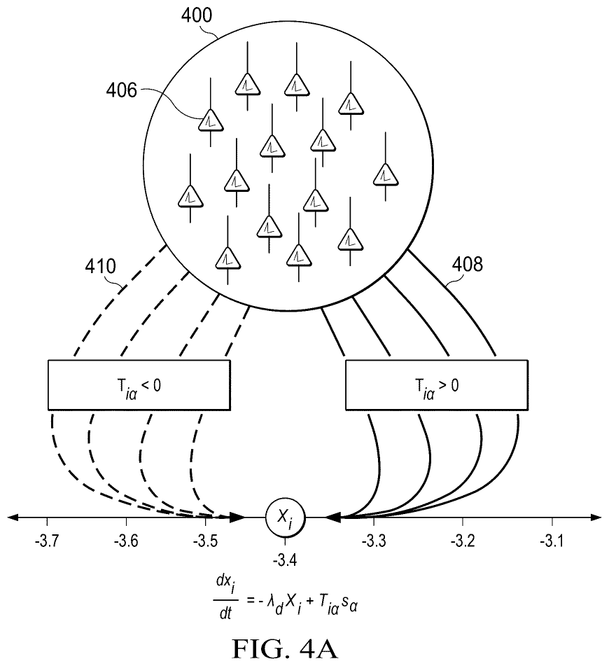

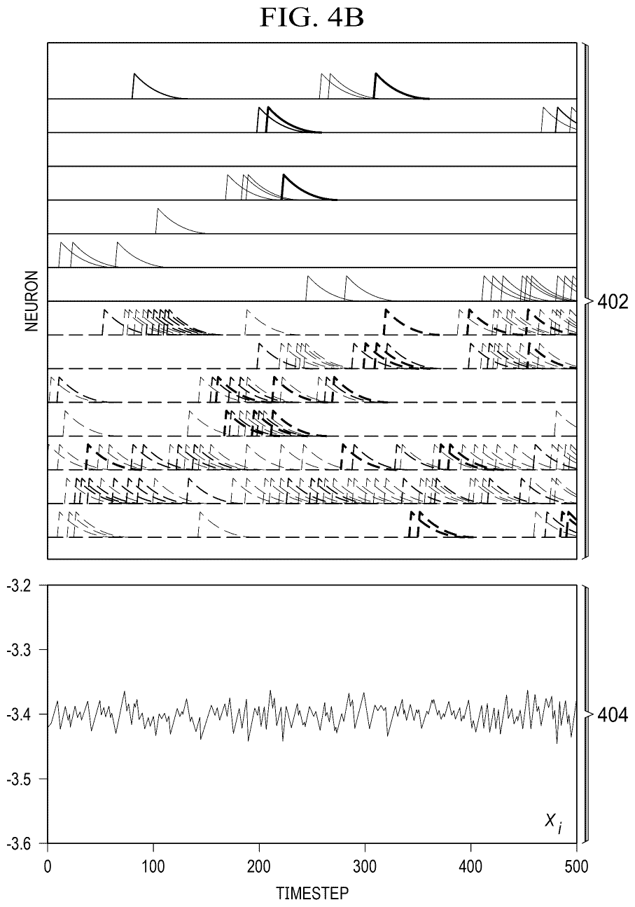

Spiking neurons 114 generate spikes in response to application of a bias current 120 that represents conditions in the linear system. Changes in the bias current 120 represent changes in the conditions of the linear system over time. These spikes 116 produce a continuous readout 122 of the mesh node 112 that represents a nodal variable 124 in the solution to the linear system (see FIGS. 3, 4A, and 4B). The timescale of readout 122 is changeable to balance convergence time and accuracy.

Synaptic weights between the spiking neurons 114 can change iteratively according to changes in the linear system resulting from solutions to the linear system at different time steps. The changes in the linear system over time can approximate the solution of a non-linear system that model a partial differential equation (PDE). The synaptic weights can change according to a schedule that is dependent on the structure of the non-linear system.

Computer system 150 is a physical hardware system and includes one or more data processing systems. When more than one data processing system is present in computer system 150, those data processing systems are in communication with each other using a communications medium. The communications medium can be a network. The data processing systems can be selected from at least one of a computer, a server computer, a tablet computer, or some other suitable data processing system.

As depicted, computer system 150 includes a number of processing units 152 that are capable of executing program code 154 implementing processes in the illustrative examples. As used herein a processor unit in the number of processing units 152 is a hardware device and is comprised of hardware circuits such as those on an integrated circuit that respond and process instructions and program code that operate a computer. When a number of processing units 152 execute program code 154 for a process, the number of processing units 152 is one or more processing units that can be on the same computer or on different computers. In other words, the process can be distributed between processing units on the same or different computers in a computer system. Further, the number of processing units 152 can be of the same type or different type of processing units. For example, a number of processing units can be selected from at least one of a single core processor, a dual-core processor, a multi-processor core, a general-purpose central processing unit (CPU), a graphics processing unit (GPU), a digital signal processor (DSP), or some other type of processor unit.

Spiking Neural Network (SNNs) incorporate the concept of time into their operating model. One of the most important differences between SNNs and other types of neural networks is the way information propagates between neurons/nodes.

Whereas other types of neural networks communicate using continuous activation values, communication in SNNs is performed by broadcasting trains of action potentials, known as spike trains. In biological systems, a spike is generated when the sum of changes in a neuron's membrane potential resulting from pre-synaptic stimulation crosses a threshold. This principle is simulated in artificial SNNs in the form of a signal accumulator that fires when a certain type of input surpasses a threshold. The intermittent occurrence of spikes gives SNNs the advantage of much lower energy consumption than other types of neural networks. A synapse can be either excitatory (i.e., increases membrane potential) or inhibitory (i.e., decreases membrane potential). The strength of the synapses (weights) can be changed as a result of learning.

The neuromorphic FEM algorithm of the illustrative embodiments is analogous to iterative methods such as Jacobi iteration, but with important differences. It inherits convergence rates depending on the underlying mesh size, limiting scalability to real problems. Traditionally, these issues have been mitigated with multigrid techniques, which is a strategy that has yet to be explored in neuromorphic algorithms. Hierarchical extension of the spiking network of the illustrative embodiments will converge at a rate independent of element size by providing shortcuts for spiking information to propagate to interior nodes. This was tested on a 1.2 billion neuron Loihi-2 platform to measure the convergence rate as a function of mesh size for finite element problems with realistic numbers of elements (104 to 106).

This work can be extended from linear PDEs like the heat equation to non-linear PDEs such as Navier-Stokes. Non-linear PDE terms map to specific synaptic plasticity dynamics within the neuromorphic circuit that allow the circuit to adapt itself to best approximate the solution.

The illustrative embodiments provide a neuromorphic finite element system incorporating the key aspects of modern finite element codes enabling broad applicability to a variety of physical problems. This neuromorphic FEM approach is a first-of-its-kind demonstration that has transformative implications for both numerical methods and neuromorphic computing. It will also influence microelectronics development by providing co-design targets for emerging devices.

The illustrative embodiments provide a neuromorphic multigrid approach crucial for efficient convergence of large finite element computations. The illustrative embodiments also apply neuromorphic synaptic plasticity rules that implement nonlinear solvers within the neuromorphic FEM algorithm. This objective exploits a clear analogy between neuromorphic synaptic plasticity and iterative methods for solving nonlinear equations.

These objectives yield a combined process possessing a high likelihood of delivering a practical neuromorphic algorithm for many finite element problems with attendant efficiency gains and affords the opportunity for revolutionizing both neuromorphic and scientific computing by demonstrating novel interpretation of finite element mathematics in the context of neuromorphic computing.

FIG. 2 depicts a diagram illustrating that mapping of spiking neurons to a FEM mesh in accordance with an illustrative embodiment. FEM mesh 200 is divided into a number of triangular elements 202 comprising nodes 204 at the vertices.

Each node 204 of mesh 200 contains a population of spiking neurons 206. The number of spiking neurons 206 corresponds to a desired level of precision of the solution to the linear system modeled by the mesh 200. The spiking neurons 206 within each node 204 connect locally with that node as well as to neighboring nodes in mesh 200. Spiking neurons within a given node project to the solution variable associated with that node with a synaptic weight for that node. Each population of spiking neurons 206 can be implemented as a low-level analog circuit comprising less than 100 (˜16-64) spiking neurons that are densely connected to each other. The analog circuits have external inputs and outputs implemented with digital spikes. The connections are relatively sparse.

Analog circuits larger than 100 neurons create scaling problems. However, assembling many smaller analog circuits together into a mesh allows efficient analog computation at each mesh node, combined with efficient digital communication between mesh nodes, to solve a big problem. As an added benefit, the spiking nature of the neural algorithm can prevent analog noise from accumulating over time.

Alternatively, each population of spiking neurons 206 can be implemented as a digital application specific integrated circuit (ASIC).

Finite element methods (FEM) approximate the solution of a partial differential equation (PDE) on a domain by discretizing the domain and equations on a mesh and solving a sparse linear system of equations. Iterative methods are popular solution techniques in cases with large meshes (>100000 elements). Meshes this large arise in practical applications where high resolution is needed to model a physical system with complex geometry.

FIG. 3 depicts the operation of a neuromorphic finite element algorithm in accordance with an illustrative embodiment. The neuromorphic finite element algorithm shown in FIG. 3 is mapped to FEM mesh 300 to solve sparse linear systems through the dynamics of a population of spiking neurons. The present example depicts the discretization of the Poisson equation (∇u=f) to a sparse linear system (A\vec{x}=b).

Each variable in the linear system is represented by a distinct neural population. Spiking neurons 306, 308 associated with each mesh node, e.g., 302, 304, respectively represent nodal variables through a spike readout. The network's estimate of the solution is maintained by an exponential decay process driven by spikes. Each spike contributes a weighted delta function perturbation to this exponential decay, expressed as:

$${\dot{x}}_{i} ( t ) = - \frac{{x}_{i}}{τ} + \to \vec{{Γ}_{ι n}} {s}_{n} \qquad Eq . 1$$

Each variable is represented through the combined action of spikes from several neurons. Equivalently, the variables are read out as a weighted low-pass filter applied to the network's spikes. The variable Γ represents a readout matrix. Every spike (Sₙ) from a neuron in a node injects a fixed amount of charge into xᵢ, and those spikes are integrated into a continuous quantity over time. If Γ is local, the connectivity matrices will be locally dense and globally sparse.

A neuron spikes if its spike will reduce the output error. Neurons with a node compete if they have similar output kernels. Neurons across nodes interact according to the FEM system geometry.

The linear system represented by FEM mesh 300 determines the connection weights between populations of spiking neurons in the mesh nodes. The network is constructed to coordinate the spikes from each variable's neurons so that this readout xt converges onto the solution of the linear system. To accomplish this convergence, synaptic weights between neurons corresponding to adjacent variables are set proportional to the nonzero element of the system matrix corresponding to these two variables. The elements of the vector b are provided as a bias current to each of the spiking neurons at a node. In the present example, the spiking neurons in node 302 are provided with bias current b; and spiking neurons in node 304 are provided with bias current bⱼ. Changes in the bias current represent changes in the conditions of the linear system over time. The neuromorphic circuit responds in near real-time to perturbations to the system represented by the changes in the bias circuit. The bias current may be provided, e.g., by a number of sensor measurements that measure inputs to the linear system.

This allows individual neurons to locally compute the current residual from the local spiking activity. Individual neurons act mathematically as a proportional-integral (PI) controller with this residual as the error, ultimately driving the neurons to spike appropriately to drive the residual to zero.

The sparsity of the linear system implies that synaptic connections are purely local, meaning that information is efficiently transferred directly between mesh nodes, significantly reducing memory bandwidth and allowing the algorithm to scale to large meshes.

FIGS. 4A and 4B illustrate the readout process of a mesh node. As shown in FIG. 4A, within each node a subset of the spiking neurons 406 in mesh node 400 output a positive Γ 408 and another subset output with a negative Γ 410, which both feed into the differential equation:

$$\frac{{dx}_{i}}{dt} = - {λ}_{d} {x}_{i} + {Γ}_{ι α} {s}_{α} \qquad Eq . 2$$

FIG. 4B illustrates the summation of neuron spikes. Panel 402 depicts the individual positive and negative spikes generated by the neurons within mesh node 400 over time. Panel 404 depicts the summation of the positive and negative spikes. The summation of the positive and negative outputs represents the time course of the nodal variable xᵢ of mesh node 400.

For the neuromorphic FEM algorithm to impact modern physics applications, it has to exhibit favorable convergence rates on practical-sized problems. Multigrid methods that are required for favorable convergence of large FEM problems can be incorporated into the neuromorphic framework of the illustrative embodiments.

FIG. 5 depicts a diagram illustrating a neuromorphic multigrid in accordance with an illustrative embodiment. Large meshes require information to travel through many elements. Neuromorphic multigrid 500 introduces multiple scales to speed convergence. Neuromorphic multigrid 500 comprises a hierarchy of FEM meshes 502, 504, 506 comprising respective corresponding spiking networks 512, 514, 516 with appropriate respective weights to provide shortcuts for spiking information to travel across the domain, likewise speeding convergence. All the FEM meshes 502, 504, 506 operate concurrently and interact with each other.

The convergence behavior of iterative finite methods depends on the spectral properties of the linear system. Matrices arising from large finite element problems appearing in applications often have a large condition number due to the small size of individual mesh elements. This large condition number implies that large problems require more iterations to converge to a desired accuracy. For classical iterative methods and realistic problems, convergence rates may be prohibitively slow.

The intuition for this phenomenon is that information from the boundary must propagate through more elements to influence the interior. This phenomenon is mitigated by multigrid methods such as shown in FIG. 5 in which the hierarchy of FEM meshes 502, 504, 506 with different resolutions provides shortcuts for information to propagate more quickly to the mesh interior. Multigrid methods use restriction and prolongation operators to transfer smoothed errors between FEM meshes in the hierarchy. The net effect is to increase the convergence rate of low-frequency modes, yielding an overall convergence rate independent of mesh size.

The neuromorphic circuit of the illustrative embodiments inherits convergence rate dependence on the condition number: as the mesh elements shrink, spikes communicating information from the boundary must travel through more neurons to affect interior nodes. Due to this spiking representation, traditional multigrid methods do not directly apply to the neuromorphic circuit of the illustrative embodiments, but the architecture of natural brains offers inspiration for an analogous solution. The dominant connectivity in natural brains is local, as in our neuromorphic circuit. However, brains often exhibit hierarchical connectivity that allows spiking information to propagate across the whole network faster than through purely local connections. Therefore, the hierarchical extension of the spiking network converges at a rate independent of element size by providing shortcuts for spiking information to propagate to interior nodes.

The advantage of the neuromorphic multigrid 500 is that the hierarchy of networks operates concurrently. The circuit transports a coarse representation of the error information between levels asynchronously. Consequently, the circuit avoids memory bottlenecks and synchronization costs inherent in the traditional multigrid cycles. Because information is transported through asynchronous spiking events, there is no need to wait for a solution at any one level to finish before transporting that information to adjacent layers; the spikes are transported as soon as they are computed. Asynchronous parallel algorithms have been identified as an important goal for high-performance numerical computing.

The multigrid prolongation and restriction operators are interpreted in the context of spiking network dynamics. This reinterpretation yields a set of synaptic weight matrices linking the hierarchy of spiking networks that correspond to different resolutions, operating in parallel, that together converge at a constant rate. The locality of error smoothing implies that these weight matrices should be sparse and local, which conforms to the optimized local communication fabric in neuromorphic processors. This will yield an overall energy efficiency gain compared to solving comparable problems on traditional von Neumann architectures.

This neuromorphic multigrid network can be instantiated on a neuromorphic platform such as, e.g., Intel Loihi 2 chips with over 1 billion artificial spiking neurons. The scale of this system allows evaluation of convergence rates on finite element meshes containing over 100,000 nodes.

To have an impact on realistic physical problems the neuromorphic FEM algorithm must handle physical systems modeled by nonlinear PDEs. The illustrative embodiments can achieve this objective by extending the neuromorphic FEM algorithm to solve nonlinear PDEs through synaptic plasticity.

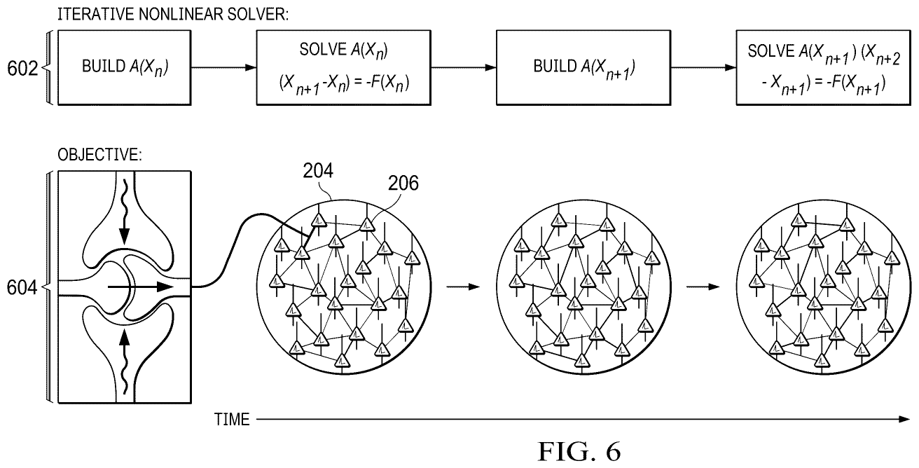

FIG. 6 depicts a diagram illustrating a nonlinear solver employing synaptic plasticity in accordance with an illustrative embodiment. Finite element models of nonlinear PDEs differ from those of linear PDEs in that the associated linear system is not constant but depends on the solution itself.

The top of FIG. 6 illustrates a traditional solver 602 that iterates build and update steps. Numerical methods for solving nonlinear systems use linear solvers to compute updates based on the linear system evaluated at the current solution estimate, then accumulate these updates to iterate towards the true solution. The linear system is rebuilt around the updated solution, and the process continues until convergence. This approach requires rebuilding the linear system at every step, incurring additional computational cost.

In contrast, the neuroplasticity application 604 enables the neuromorphic network to update itself through time to solve the nonlinear system. In the neuromorphic circuit, the linear system being solved is instantiated in the synaptic connections between the populations of spiking neurons 206 at each node 204. Thus, a changing linear system characteristic of nonlinear problems will manifest as a change in the synaptic weights—in other words, through synaptic plasticity. Local synaptic plasticity is a mechanism by which spiking networks modify their own connectivity concurrently with their evolution through a dynamical rule at each synapse. Nonlinear PDE terms manifest as characteristic synaptic plasticity rules. Implementing these plasticity rules allows the neuromorphic FEM algorithm to efficiently solve nonlinear finite element problems.

The advantage of a neuromorphic nonlinear solver with synaptic plasticity is that the concurrent spiking and plasticity dynamics couple the linear solve and nonlinear updates without the need to rebuild the network at each iteration. This is a form of computation in memory (CIM), as the computations necessary to adapt the linear system through the nonlinearities happen at the same location at which that information is stored—namely, the synapses.

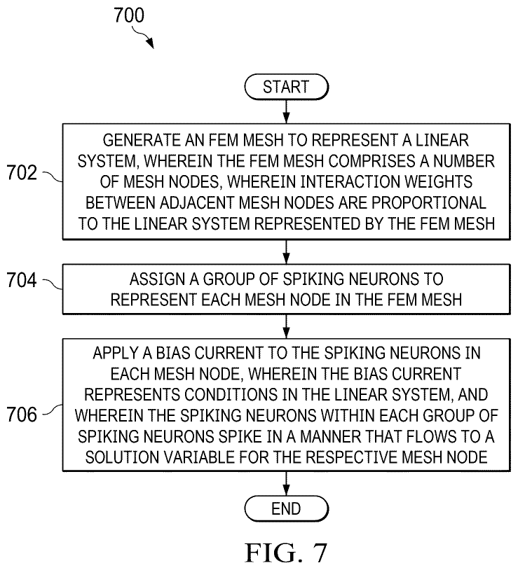

FIG. 7 depicts a flowchart illustrating process for instantiating a finite element methods (FEM) mesh in a spiking neuromorphic circuit in accordance with an illustrative embodiment. Process 700 can be implemented in finite element system 100 shown in FIG. 1.

Process 700 begins by generating the FEM mesh to represent a linear system, wherein the FEM mesh comprises a number of mesh nodes (step 702). Interaction weights between adjacent mesh nodes are proportional to the linear system represented by the FEM mesh. The linear system may be a sparse linear system.

The FEM mesh may be one of a number of meshes arranged hierarchically, wherein the FEM meshes represent the linear system at different levels of resolution that operate concurrently and interact with each other, wherein the overall convergence rate is independent of FEM mesh size. The FEM meshes may be connected by weight matrices that correspond to relaxation and prolongation operators.

A group of spiking neurons are assigned to represent each mesh node in the FEM mesh (step 704). The spiking neurons within each group of neurons connect locally within the mesh node and to neighboring mesh nodes in the FEM mesh.

A bias current is applied to the spiking neurons in each mesh node, wherein the bias current represents conditions in the linear system, and wherein the spiking neurons within each group of spiking neurons spike in a manner that flows to a solution variable for the respective mesh node (step 706). Spikes from each spiking neuron within each group of spiking neurons contribute to a continuous readout of nodal variables. Within each group of spiking neurons, a first subset of spiking neurons generates positive outputs and a second subset of spiking neurons generates negative outputs, wherein summation of the positive and negative outputs represents a time course of the nodal variable of that mesh node. Synaptic weights between the spiking neurons change iteratively according to changes in the linear system resulting from solutions to the linear system at different time steps. The changes in the linear system over time can approximate the solution of a non-linear system that model a partial differential equation (PDE).

Process 700 then ends.

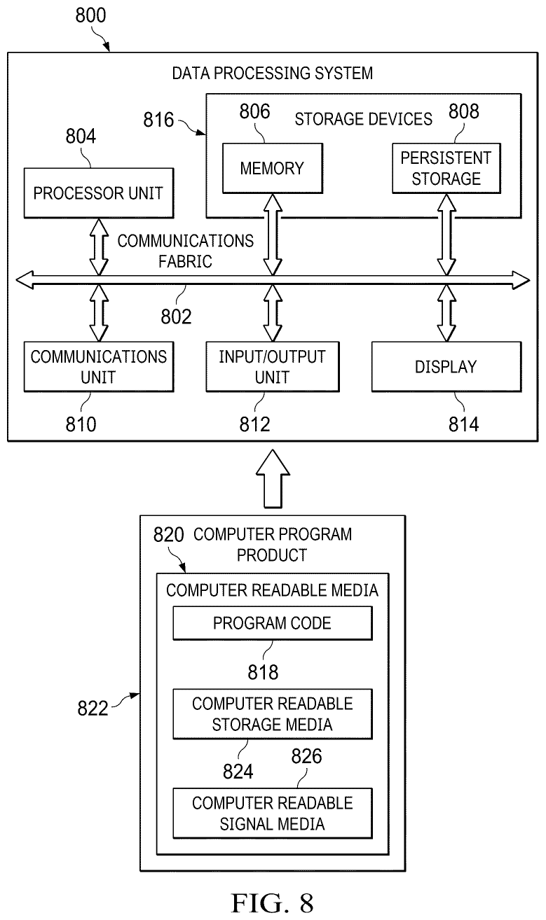

Turning now to FIG. 8, an illustration of a block diagram of a data processing system is depicted in accordance with an illustrative embodiment. Data processing system 800 may be used to implement computer system 150 in FIG. 1. In this illustrative example, data processing system 800 includes communications fabric 802, which provides communications between processor unit 804, memory 806, persistent storage 808, communications unit 810, input/output unit 812, and display 814. In this example, communications fabric 802 may take the form of a bus system.

Processor unit 804 serves to execute instructions for software that may be loaded into memory 806. Processor unit 804 may be a number of processors, a multi-processor core, or some other type of processor, depending on the particular implementation. In an embodiment, processor unit 804 comprises one or more conventional general-purpose central processing units (CPUs). In an alternate embodiment, processor unit 804 comprises one or more graphical processing units (GPUs).

Memory 806 and persistent storage 808 are examples of storage devices 816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 816 may also be referred to as computer-readable storage devices in these illustrative examples. Memory 806, in these examples, may be, for example, a random access memory or any other suitable volatile or non-volatile storage device. Persistent storage 808 may take various forms, depending on the particular implementation.

For example, persistent storage 808 may contain one or more components or devices. For example, persistent storage 808 may be a hard drive, a flash memory, a rewritable optical disk, a rewritable magnetic tape, or some combination of the above. The media used by persistent storage 808 also may be removable. For example, a removable hard drive may be used for persistent storage 808. Communications unit 810, in these illustrative examples, provides for communications with other data processing systems or devices. In these illustrative examples, communications unit 810 is a network interface card.

Input/output unit 812 allows for input and output of data with other devices that may be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs may be located in storage devices 816, which are in communication with processor unit 804 through communications fabric 802. The processes of the different embodiments may be performed by processor unit 804 using computer-implemented instructions, which may be located in a memory, such as memory 806.

These instructions are referred to as program code, computer-usable program code, or computer-readable program code that may be read and executed by a processor in processor unit 804. The program code in the different embodiments may be embodied on different physical or computer-readable storage media, such as memory 806 or persistent storage 808.

Program code 818 is located in a functional form on computer-readable media 820 that is selectively removable and may be loaded onto or transferred to data processing system 800 for execution by processor unit 804. Program code 818 and computer-readable media 820 form computer program product 822 in these illustrative examples. In one example, computer-readable media 820 may be computer-readable storage media 824 or computer-readable signal media 826.

In these illustrative examples, computer-readable storage media 824 is a physical or tangible storage device used to store program code 818 rather than a medium that propagates or transmits program code 818. Computer readable storage media 824, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 818 may be transferred to data processing system 800 using computer-readable signal media 826. Computer-readable signal media 826 may be, for example, a propagated data signal containing program code 818. For example, computer-readable signal media 826 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 800 are not meant to provide architectural limitations to the manner in which different embodiments may be implemented. The different illustrative embodiments may be implemented in a data processing system including components in addition to or in place of those illustrated for data processing system 800. Other components shown in FIG. 8 can be varied from the illustrative examples shown. The different embodiments may be implemented using any hardware device or system capable of running program code 818. As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A spiking neuromorphic circuit that instantiates a finite element methods (FEM) mesh, the circuit comprising:
a number of groups of spiking neurons, wherein each group of spiking neurons represents a mesh node in the FEM mesh, wherein the FEM mesh represents a linear system; and
a bias current that represents conditions in the linear system;
wherein interaction weights between adjacent mesh nodes are proportional to the linear system represented by the FEM mesh; and
wherein the spiking neurons within each group of spiking neurons spike in a manner that flows to a solution variable for the respective mesh node.

2. The circuit of claim 1, wherein the number of spiking neurons corresponds to a desired level of precision of a solution to the linear system.

3. The circuit of claim 1, wherein the spiking neurons within each group of neurons connect locally within the mesh node and to neighboring mesh nodes in the FEM mesh.

4. The circuit of claim 1, wherein spikes from each spiking neuron within each group of spiking neurons contribute to a continuous readout of nodal variables.

5. The circuit of claim 4, wherein timescales of readouts are changeable to balance convergence time and accuracy.

6. The circuit of claim 5, wherein, within each group of spiking neurons, a first subset of spiking neurons generates positive outputs and a second subset of spiking neurons generates negative outputs, wherein summation of the positive and negative outputs represents a time course of the nodal variable of that mesh node.

7. The circuit of claim 1, wherein the bias current is provided by a number of sensor measurements that measure inputs to the linear system.

8. The circuit of claim 1, wherein changes in the bias current represent changes in the conditions of the linear system over time.

9. The circuit of claim 8, wherein the neuromorphic circuit responds in near real-time to perturbations to the system represented by the changes in the bias current.

10. The circuit of claim 1, wherein the FEM mesh is one of a number of meshes arranged hierarchically, wherein the FEM meshes represent the linear system at different levels of resolution, and wherein overall convergence rate is independent of FEM mesh size.

11. The circuit of claim 10, wherein the FEM meshes are connected by weight matrices that correspond to relaxation and prolongation operators.

12. The circuit of claim 10, wherein all the FEM meshes operate concurrently and interact with each other.

13. The circuit of claim 1, wherein synaptic weights between the spiking neurons change iteratively according to changes in the linear system resulting from solutions to the linear system at different time steps.

14. The circuit of claim 13, wherein the changes in the linear system over time approximate the solution of a non-linear system that model a partial differential equation (PDE).

15. The circuit of claim 14, wherein the synaptic weights change according to a schedule that is dependent on the structure of the non-linear system.

16. The circuit of claim 1, wherein the linear system is a sparse linear system.

17. The circuit of claim 16, wherein the sparse linear system models a linear partial differential equation (PDE).

18. The circuit of claim 1, wherein each of the groups of spiking neurons comprises an analog circuit.

19. The circuit of claim 18, wherein each analog circuit comprises less than 100 spiking neurons connected to each other.

20. The circuit of claim 18, wherein the analog circuit comprises external inputs and outputs implemented with digital spikes.

21. The circuit of claim 1, wherein each of the groups of spiking neurons comprises a digital application specific integrated circuit (ASIC).

22. A spiking neuromorphic circuit that instantiates a finite element methods (FEM) problem for a sparse linear system, the circuit comprising:
a number of analog circuits, wherein each analog circuit comprises a number of spiking neurons, wherein external inputs and outputs of the analog circuits are implemented with digital spikes, wherein each analog circuit corresponds to a mesh node in one of a number of hierarchically arranged FEM meshes that represent the linear system at different levels of resolution, wherein overall convergence rate is independent of FEM mesh size, wherein synaptic weights between the spiking neurons change iteratively according to changes in the linear system resulting from solutions to the linear system at different time steps, wherein interaction weights between adjacent mesh nodes are proportional to the sparse linear system represented by the FEM meshes, and wherein all FEM meshes operate concurrently and interact with each other via weight matrices that correspond to relaxation and prolongation operators; and
a bias current that represents conditions in the sparse linear system, wherein changes in the bias current represent changes in the conditions of the sparse linear system over time, and wherein the spiking neurons within each analog circuit spike in a manner that flows to a solution variable for the respective mesh node.

23. A method of instantiating a finite element methods (FEM) mesh in a spiking neuromorphic circuit, the method comprising:
generating the FEM mesh to represent a linear system, wherein the FEM mesh comprises a number of mesh nodes, wherein interaction weights between adjacent mesh nodes are proportional to the linear system represented by the FEM mesh;
assigning a group of spiking neurons to represent each mesh node in the FEM mesh; and
applying a bias current to the spiking neurons in each mesh node, wherein the bias current represents conditions in the linear system, and wherein the spiking neurons within each group of spiking neurons spike in a manner that flows to a solution variable for the respective mesh node.
